(19) United States
(12) Patent Application Publication
(10) Pub. No.: US 2003/0038402 A1
(43) Pub. Date: Feb. 27, 2003

(54) Method and apparatus for producing a multipurpose panel with structural, functional, and energy absorbing features

(76) Inventors: Carl Henry Visconti, Clarkston, MI (US); Edward Joseph Wenzel, Troy, MI (US)

Correspondence Address: PATRICK M. GRIFFIN, DELPHI TECHNOLOGIES, INC., Legal Staff, P.O. Box 5052, Mail Code: 480-414-420, Troy, MI, 48007-5052, US

(21) Appl. No.: 09/934,190

(22) Filed: Aug. 21, 2001

(51) Int. Cl. B29C 43/20

(52) U.S. Cl. 264/257; 264/324; 264/46.5; 264/325

(57) ABSTRACT

A method of making a panel by depositing a first extrudate into a mold cavity and pressing the first extrudate with a mold core to form a skin layer. The skin layer is cooled inside the mold cavity. A core material is loaded in the mold cavity onto the skin layer. A second extrudate is deposited into the mold cavity and onto the core. The second extrudate forms a structure layer. The mold core is pressed against the structure layer so that the structure layer forms around the core. The pressure of the mold core against the structure layer also presses the core into the skin layer. The structure layer and the skin layer cool while the mold core is pressed against the structure layer and the core material and the skin layer to form a panel. The panel is removed from the mold cavity.

### CROSS REFERENCE TO RELATED APPLICATIONS

This application is related to U.S. application Ser. No. 09/268,198, filed on Mar. 11, 1999. This application is also related to U.S. application Ser. No. 09/695,652, filed Oct. 24, 2000, the contents of which are incorporated herein by reference thereto.

### TECHNICAL FIELD

This disclosure relates to an apparatus and method for manufacturing molded items, and more particularly, an apparatus and method for manufacturing a panel for a vehicle.

### BACKGROUND

Vehicles have various interior body parts which present an aesthetically appealing appearance, as well as a functional utility. The interior body parts may include door trim panels, instrumentation panels, and ceiling panels. These panels serve to dampen sound, provide structural support, and absorb kinetic energy for the protection of passengers.

The makeup of these panels typically includes multiple components arranged in substrates or layers of varying shapes and materials. An external component material usually has an aesthetic appearance, and the internal component material serves to provide physical utilitarian functions as stated above.

Since the panels are made from multiple components, the final product may be a product of an assembly process. The components are conventionally assembled together by several different techniques such as lamination by use of adhesives, heat staking, sonic welding and injection molding. The conventional panels with multiple components increase the cost of manufacture, since each component is individually produced and then brought together for final assembly. The processes used to bond the components together inherently limit the material composition and the structural forms of the panels.

Some lamination processes are limited to materials that are compatible with the process and also limit surface contour and decoration.

Injection molding limits mold designs and can leave a contoured panel shape with excessive thinness in certain locations. The injection molding process requires excessive use of materials due the inherent limitations of the process, a few being high mold injection pressures and limited mold injection locations.

Accordingly, it is desirable to reduce the number of components and the cost associated with the purchase and assembly of a panel assembly. It is also desirable to reduce the time-consuming tasks associated with the multiple steps involved in the above-mentioned processes.

The present invention utilizes the molding characteristics of an extrusion deposit compression molding process (EDCM), also known as extrusion compression molding, melt compression molding, or back compression molding, to mold an item.

EDCM is an open mold process, and this feature allows for the use of specific processing techniques to combine different polymer materials and/or inserts within the same tool or mold cavity.

According to the present invention an EDCM apparatus includes at least two separate deposition units each one having an extrusion die. Each deposition unit pushes a material through the die.

The EDCM apparatus also includes a compression mold which is molded of first and second mold dies which mate with one another so as to mold an item.

The apparatus is manipulated so that the extrusion die heads are passed over the mold to thereby deposit different materials into predetermined areas of the mold cavity. For example, a first material is deposited into the required sections of the mold cavity so as to mold one portion of an item. The second material is deposited in another section to mold another portion of the item.

The first and second materials have different characteristics and provide different features to the mold. It will be appreciated that the first material and the second material may be different thermoplastics of differing resiliency, strength, flexibility etc.

In addition, the open mold process allows the extrusion deposition unit to pass over the mold area regardless of its shape. Thus, the unit deposits the required molten material within the mold thereby reducing the required amount of flow of material to fill all of the cavities of the mold.

Furthermore, it will also be appreciated that the first material may contain an amount of reinforcing material and the second material may contain an amount of reinforcing material, wherein the amount and type of reinforcing material used in the first and second materials may be the same or they may be different.

The mold is closed and the deposited materials within the mold cavity fill out the mold cavity under pressure and the mold is opened after the required cooling time. The resultant molded article includes the different materials which mold the item.

The EDCM process provides a manufacturing cost reduction which is realized due to optimal material usage. Optimal material usage is accomplished by one or more of the following alternatives: (1) a lower cost material may be used for any specific area of the part due to the application of optimum reinforcement material and placement and use of the optimum material for each function and (2) the present invention provides the ability to mold thinner sections across the structural beam as may be justified by structural analysis. Additional cost savings are achieved through lower cost tooling and reduced tonnage equipment.

The EDCM process requires lower pressures as compared to other molding processes and accordingly results in a reduction in the tonnage of force and machinery required by the process. In addition, the EDCM process allows the use of more complex molds therefore the molded item will have fewer attached parts as they can be mold directly. By eliminating or using fewer attached parts, there is reduced opportunity for squeaks and rattles and other quality deficiencies to occur.

Other advantages of the present invention are discussed herein and include improved recyclability, a reduction in production costs, and ease of manufacture.

### SUMMARY

A panel is capable of being manufactured so that the panel is aesthetically appealing and functional for use in vehicles. The process to make the panel can also be less costly and performed with fewer parts. The panelis produced using a compression mold which is comprised of first and second mold dies which mate with one another so as to mold an item. A method of making a panel can be performed by utilizing the EDCM process to deposit a first extrudate into a first mold die also referred to as a mold cavity. A second mold die also referred to as a mold core is pressed against the first extrudate to form a skin layer. The skin layer is partially or completely cooled inside the mold cavity between the first and second mold dies. The second mold die is raised or moved away from the first mold die, and a core material is loaded in the first mold die onto the skin layer. A second extrudate is deposited into the first mold die and onto the core material. The second extrudate forms a structure layer. The second mold die is pressed against the structure layer so that the structure layer forms around the core material. The pressure of the second mold die against the structure layer also presses the core material into the skin layer. The structure layer and the skin layer cool while the second mold die is pressed against the structure layer, the core material, and the skin layer to form a panel. The panel is removed from the mold cavity.

The above described and other features and advantages of the present invention will be appreciated and understood by those skilled in the art from the following detailed description, drawings, and claims.

### BRIEF DESCRIPTION OF THE DRAWINGS

The present invention will now be described, by way of example only, with reference to the accompanying drawings wherein:

FIG. 1 is a perspective view of a molding apparatus used in an exemplary embodiment of the present invention;

FIG. 2 is a side view of an extrusion/deposition unit for use in the apparatus of FIG. 1;

FIG. 3 is a top plan view of an exemplary molding apparatus for use in the manufacturing disclosed herein;

FIG. 4 is a top plan view of a mold portion for use with the molding apparatus of FIGS. 1-3;

FIG. 5 is a perspective view of a molding apparatus used in an exemplary embodiment of the present invention;

FIG. 6 is a side view of an extrusion/deposition unit for use in the apparatus of FIG. 5;

FIG. 7 is a perspective view of an exemplary embodiment of a blank core material for a molded item.

FIG. 8 is a side view of an exemplary embodiment of an extrusion deposition unit with a mold tool;

FIG. 9 is a side view of an exemplary embodiment of a mold tool with extrudate;

FIG. 10 is a side view of an exemplary embodiment of an extrusion deposition unit and mold tool with extrudate and a core material;

FIG. 11 is a side view of an exemplary embodiment of a mold tool with layers of extrudate disposed around a core material;

FIG. 12 is a perspective view of an item formed by the process of an exemplary embodiment of the present invention;

FIGS. 13-16 are partial cross-sectional views of a mold core for forming in accordance with an exemplary embodiment of the present invention; and

FIG. 17 is a cross sectional view of an alternative embodiment.

### DESCRIPTION OF THE PREFERRED EMBODIMENT

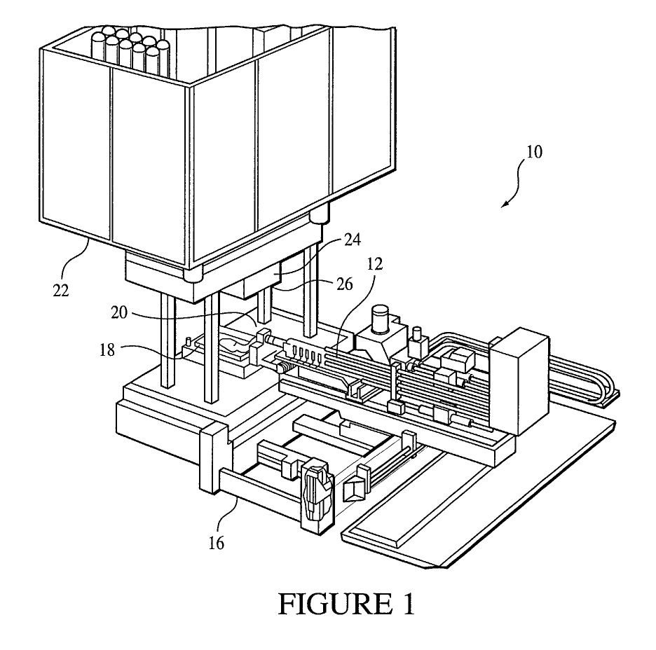

Referring to FIGS. 1-4 an extrusion deposition compression molding (EDCM) apparatus 10 is shown. The exemplary molding apparatus 10 is used with a molding process or such extrusion deposit compression molding (EDCM), or extrusion compression molding, or melt compression molding, or back compression molding, or compression molding of molten thermoplastic materials. The apparatus has an extrusion/deposition unit 12 mounted on a positioner 16. The positioner is preferably a programmable X-Y-Z positioner.

Positioner 16 relocates or moves the extrusion/deposition units so that a melted polymer may be disposed across a first mold cavity 18 of a mold 20. The first mold cavity 18 embodies a portion of the shape of the item to be molded.

Molten thermoplastic is disposed into the first mold cavity 18 from the extrusion/deposition units until the required amount of material is deposited within the first mold cavity 18. The first mold cavity is positioned and secured onto the lower platen of a press 22. Press 22 has a deployable member 24, also known as the upper platen, on which is positioned and secured a second mold cavity 26. Second mold cavity 26 is a complementary to first mold cavity 18. Accordingly, and after the molten thermoplastic is deposited within the first mold cavity 18, the press lowers the second mold cavity 26 over the first mold cavity causing the deposited thermoplastic material flow and to be molded by the first and second mold cavities. It is also noted that first mold cavity 18 and second mold cavity 26 are removable so that other mold cavities can be appropriately placed to mold other objects.

In an exemplary embodiment, press 22 is a hydraulic press, however, other presses capable of lowering the second mold cavity over the first with the required amount of force are also contemplated to be within the scope of the present invention.

Press 22 exerts a force on the second mold cavity 26 which makes contact with the exposed surface of the molten thermoplastic as well as provides a boundary for the molten thermoplastic to take form and cool or set after being deposited or disposed in the first mold cavity 18.

In addition, press 22 will maintain the pressure on the materials that are being molded (typically molten thermoplastic) as the materials cool and shrink or set. Thus, there will be no deformations in the item being molded due to shrinkage or settling within the mold. This can be accomplished through the use of a thermister or other temperature measuring device to determine when the molded part has reached the proper temperature for demolding, or it can be accomplished by waiting the proper amount of time prior to demolding. In addition, or as an alternative, a pressure gauge can be positioned to measure the pressure between first mold cavity 18 and second mold cavity 26. Thus, the information from the thermister or pressure gauge or both can be supplied to a controller which will maintain or possibly increase the pressure being applied by press 22.

For example, the molten thermoplastic is generally in an expanded state when compared to its cooled or cured temperature. Thus, press 22 must apply a greater force when the molten thermoplastic is in the mold. In addition, and when the material cools, the press will have to lower the second mold cavity in order to maintain contact with the curing material.

Accordingly, a more uniform shape in the item being molded is maintained by having a continuous pressure force applied by the press 22. By pressing and following the materials in the mold cavity as they contract, the press 22 also eliminates stresses and defects that may result from the shrinkage of the molten thermoplastic.

As an alternative to lowering the second mold cavity and maintaining the pressure on the cooling thermoplastic materials, the second cavity may be stopped using stop blocks at a specified component thickness. This is done when the thermoplastic material includes a blowing or foaming agent or when one of the inserted non-molten materials is compressed during the lowering of the second mold cavity, but it also can be done using only thermoplastic materials that have minimal shrink or that otherwise do not result in problems due to shrinkage.

As a further alternative, the second mold cavity 26, after being lowered onto the first mold cavity 18, can be lifted away from the melted thermoplastic a minimal amount and lowered again, and this can be done several times during the cycle of molding a part.

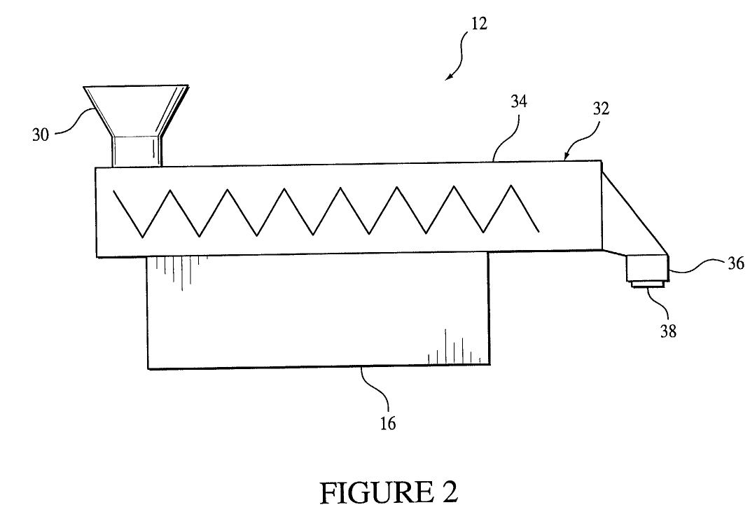

Referring now to FIG. 2, an extrusion/deposition unit 12 is shown. In an exemplary embodiment, two extrusion/deposition units are mounted on the positioner. Of course, additional extrusion/deposition units may be used depending on the number of different materials needed to mold the item. The velocity of the movement of the extrusion/deposition unit can vary the quantity of molten thermoplastic or molten polymer deposited. The extrusion/deposition unit can also vary the quantity of molten polymer by the rate of injection.

The extrusion/deposition unit 12 has a feed element 30. Feed element 30 provides an opening for receiving a polymer to be heated and deposited by the extrusion/deposition unit. Typically the polymer is in pelletized form and is melted by a heating element disposed within the unit and by the shear force provided within the plastication unit 32. As an alternative, a separate extruder could be used to feed melted thermoplastic into the extrusion/deposition unit, and this extruder could be fed by plastic pellets and/or fiber materials.

The extrusion/deposition unit has a plastication/injection unit 32 configured to receive the materials from feed element 30. Plastication/injection unit 32 has a plurality of internal components within a barrel portion 34. The plurality of internal components include but are not limited to the following: a screw or screws for receiving the pelletized polymers and additional fibers for reinforcement, the screws mix and arrange and apply shear forces to the pelletized polymer; a plurality of heating bands for heating and melting the pelletized polymer and a hydraulic piston/ram for forcing the screw forward and thereby forcing the molten polymer out of an extrusion die opening 36. The amount of distance that the hydraulic piston and screw move forward determines the overall amount of melted thermoplastic deposited onto the mold cavity, and the speed of the hydraulic piston/screw movement determines the flow rate of the material. The size to die opening will also affect the shape of the molten polymers.

The extrusion die opening can be configured to have a fixed opening of most any shape. For example, the fixed opening may be a circle, rectangle, triangle, star etc. Alternatively, a slidable member 38 with a plurality of variable openings can be positioned to provide alternative openings for each issue die opening 36.

The extrusion/deposition unit conveys the molten plastic materials to the extrusion die opening and can provide a means for metering the amount of molten polymer out of the extrusion die opening and accordingly onto the mold cavity. In addition, the amount of molten polymer that is deposited within the mold cavity may be varied by the overall amount of movement of the hydraulic ram. The localized amount of material deposited can be varied by the speed of the hydraulic ram and positioner.

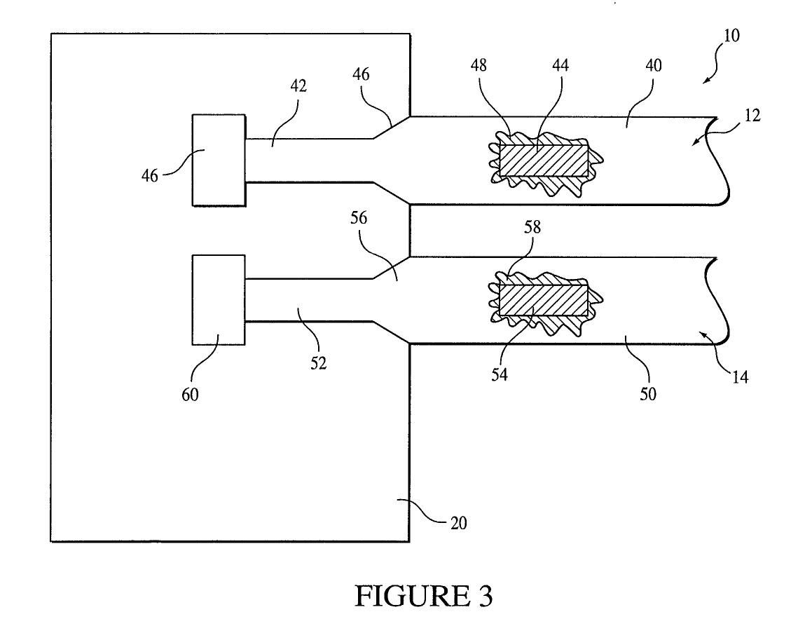

Referring now to FIG. 3, portions of apparatus 10 are shown. Here, the apparatus broadly comprises an extrusion compression molding apparatus (or EDCM or back compression molding) according to one embodiment of the present invention, the apparatus comprises a first extrusion/deposition unit 12 and a second extrusion/deposition unit 14.

An alternative type of extrusion/deposition unit 12 and 14 can consist of a cylindrical plunger with a similar extrusion die. This plunger unit can be fed molten plastic material, with or without fiber reinforcement or other additives, from a separate extruder. Plastic pellets and/or fiber materials are fed into the extruder. By moving the ram of the plunger forward, melted thermoplastic can be forced out of the extrusion die, and the amount of movement and the speed of the movement can be used to control the amount of material and flow rate as required.

As another alternative method to an apparatus that includes two extrusion/deposition units that deposit the molten plastic onto the first mold cavity, one or both of the extrusion/deposition units can deposit or extrude a specific volume of material onto a conveyor or other platform, and this deposited/extruded material can then be transferred using a robot or other method of automated transfer to the first mold cavity.

The first extrusion/deposition unit 12 includes a barrel section 40 having an inlet section (not shown) and an opposing outlet section 42. The barrel section 40 contains an injection/plastication screw, partially indicated at 44, which longitudinally extends the length of the barrel section 40. The illustrated first extrusion/deposition unit 12 further has a neck section 45 that is formed between the barrel section 40 and the outlet section 42. The injection/plastication screw 44 is rotatably mounted within the barrel section 40 and is designed to advance polymeric material through the barrel section 40 at elevated temperatures and under pressure that causes the polymeric material to become a polymer melt.

Typically, the injection/plastication screw 44 has a number of flights which are usually wrapped in a helical manner around the body of the injection/plastication screw. The polymeric material is generally introduced into the first extrusion/deposition unit 12 in a solid form, such as plastic pellets, and then the rotational movement of the injection/plastication screw 44 and the flights causes the polymeric material to be conveyed within the barrel section 40 toward the outlet section 42 and through a heated compacted environment where the material is heated under carefully controlled conditions to melt the polymeric material (to form a melt 48) and the material is mixed to a reasonably uniform temperature while the melt is pressurized and pumped forward toward the outlet section 42.

A first extrusion die 46 is connected to the outlet section 42 and includes a die channel (not shown) included therein. The die channel fluidly communicates with the outlet section 42 so that the melt advances through the outlet section 42 and into the die channel. One end of the die channel thus comprises a deposit opening in which the melt (extrudate) is discharged through. The first extrusion die 46 and more specifically, the die channel may have any number of shapes so that the stream of extrudate which exits the first extrusion/deposition unit 12 has a desired shape. The first extrusion die 46 is not always the same dimension. The first extrusion die 46 may change in order to match the varying composition across the part (e.g., larger openings for larger mold areas).

It will be appreciated that a reinforcing material may be added to the melt at any number of locations along the first extrusion/deposition unit 12 so as to form a fiber-reinforced extrudate. Alternatively, the reinforcing fiber may be already in the plastic pellets. This is particularly advantageous when it is desired to further enhance or alter the material and/or performance characteristics of the extrudate.

As will be described in greater detail hereinafter, certain portions of the resultant molded structure produced by the present process require different material characteristics than other portions of the structure. For example, the manufacture of one portion may require additional fiber reinforcement because it is desired to increase the structural properties of this one portion of the structure. It is within the scope of the present invention that any number of suitable fibers may be used as the reinforcing material. While it may be possible to manufacture the entire article out of a single material, this may not always be the most optimal, cost effective method. The use of the material with the highest reinforcement across the entire article, for example can result in reinforcement where it is not required and special design considerations where more energy absorption is required.

In the illustrated embodiment, the second extrusion/deposition unit 14 is similar to the first extrusion/deposition unit 12 and is spaced apart therefrom. It will be appreciated that the second extrusion/deposition unit 14 does not necessarily have to be identical or similar to the first extrusion/deposition unit 12 so long as both the first and second extrusion/deposition units 12, 14 are intended for use in an extrusion deposit compression molding process.

According to the present invention, the first and second extrusion/deposition units 12, 14 are each designed to move in the x, y, and z directions so that each of the first and second extrusion/deposition units 12, 14 may be properly positioned relative to a first mold die which is generally indicated at 18. The designations of x, y, and z are typical of any three-axis movement, with x being into and out of the press space, y being lateral movement with respect to the x axis, and z being vertical with respect to the x axis. In a simplified version of this invention, the first and second extrusion/deposition units 12, 14 can be designed to move only the in x direction or only in the x and z directions or x and y directions. For simplicity, the first mold die 18 is not shown in detail and FIG. 3 is intended to convey the spatial relationship between the first mold die 18 and the first and second extrusion/deposition units 12, 14. The first and second extrusion/deposition units may be connected to one another so that movement of one causes the simultaneous movement of the other or each of the first and second extrusion/deposition units 12, 14 may move independent from the other.

The second extrusion/deposition unit 14 is similar to unit 12 in that it includes a barrel section 50 having an inlet section (not shown) and an opposing outlet section 52. The barrel section 50 contains an injection/plastication screw, partially indicated at 54. The illustrated second extrusion/deposition unit 14 further has a neck section 56 formed between the barrel section 50 and the outlet section 52. The injection/plastication screw 54 is rotatably mounted within the barrel section 50 and is designed to advance polymeric material through the barrel section 50 at elevated temperatures and under pressure which causes the polymeric material to become a polymer melt generally indicated at 58. Typically, the injection/plastication screw 50 has a number of flights which are usually wrapped in a helical manner around the body of the injection/plastication screw.

A second extrusion die 60 is connected to the outlet section 52 and includes a second die channel (not shown) formed therein. The second die channel fluidly communicates with the outlet section 52 so that the melt advances through the outlet section 52 and into the second die channel. One end of the second die channel thus comprises a deposit opening in which the melt (extrudate) is discharged through. The second extrusion die 60 and more specifically, the second die channel, may have any number of shapes so that the stream of extrudate which exits the second extrusion/deposition unit 14 has a desired shape. It will be appreciated that a reinforcing material may be added to the melt at any number of locations along the second extrusion/deposition unit 14 including in the pellets so as to form a fiber-reinforced extrudate.

Because the molding apparatus 10 includes first and second extrusion/deposition units 12, 14 each having a separate extrusion/deposition head, namely first and second extrusion dies 46, 60, respectively, each extrusion/deposition unit 12, 14 may contain a different polymer material used to form the extrudate and furthermore the type and/or amount of reinforcing fiber may be varied between the first and second extrusion/deposition units 12, 14. There may be two different materials in the same mold die 18.

Thus according to the present invention, the first extrusion/deposition unit 12 may be used to deposit a first extrudate in the mold die 18 and the second extrusion/deposition unit 14 may be used to deposit a second extrudate in the mold die 18. This results in the ability of the operator to tailor the construction of the resultant molded article.

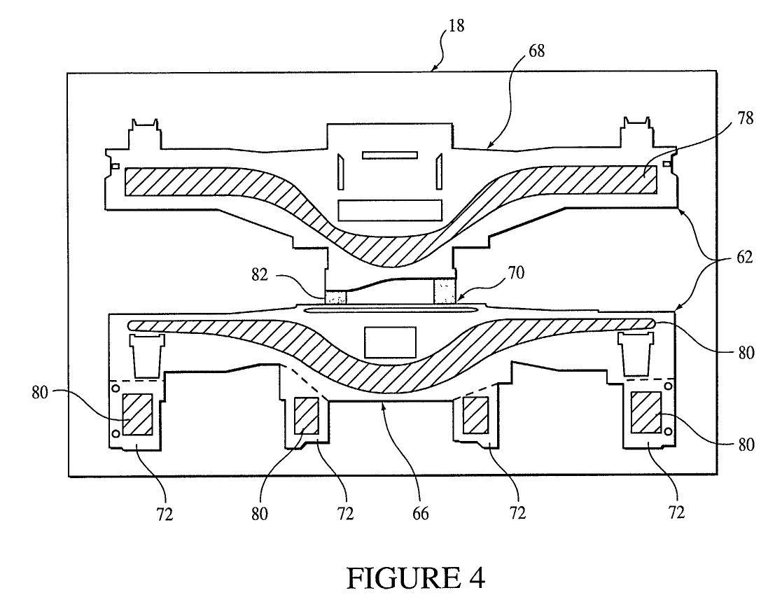

Referring now to FIGS. 3 and 4. FIG. 4 is a top plan view of one configuration of first mold die 18. In a compression molding process, the mold is formed of two complementary parts, namely the first mold die 18 and a second mold die (not shown) which mates with the first mold die 18 under compressive forces so as to fill-out the first and second molds with the extrudate. In an extrusion deposit compression molding process, the extrudate is deposited onto the first mold die 18 and then the first and second mold dies are closed and compressed under pressure.

Referring now to FIG. 4, the first mold die 18 shown in FIG. 4 includes a cavity, generally indicated at 62, for receiving one or more extrudates from the first and second extrusion/deposition units 12, 14. The cavity 62 generally has the shape of the resultant molded article so that compression of the first and second mold dies under pressure results in the molded article being formed. Of course, the process disclosed herein may form any item of any configuration.

The cavity 62 actually is formed of a first section 66 and a second section 68 with a hinge section 70 being formed therebetween. For some designs, the cavity 62 may actually be molded of three separate sections. In addition, these sections could actually be individual mold cavities mounted together in one press or in separate presses. More specifically, the first section 66 is formed of a recessed section of the first mold die 18. The hinge section 70 comprises one or more recessed portions of the first mold die 18 which link the first section 66 with the second section 68 and thus these recessed portions comprise hinge sections.

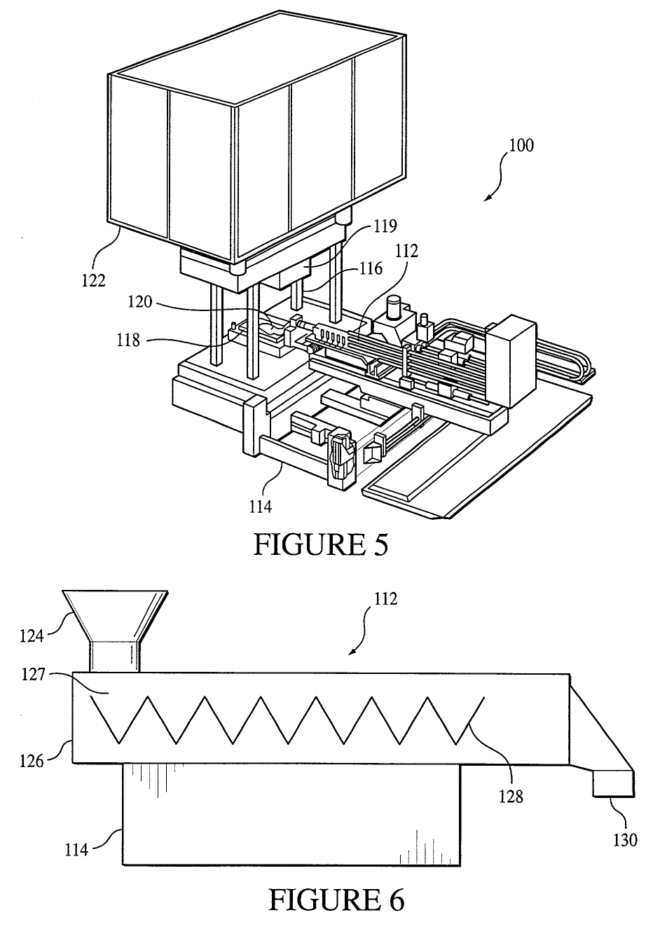

In an exemplary embodiment, the process for manufacturing a panel 90 will now be described with reference to FIGS. 5-12. The process of molding the panel 90 using the equipment referenced above involves several steps. In general, a molding apparatus 100 is set up to process the panel 90 from an extrudate 134 and core material 138 disposed into a mold tool 118. An extrusion deposition unit 112 provides the extrudate 134 and deposits the extrudate 134 into a mold cavity 116 also referred to as the first mold die. The core material 138 is combined with the extrudate 134 in the mold cavity 116. A mold core 119 also referred to as the second mold die is pressed onto the core material 138 and the extrudate 134. Additional extrudate 134 is deposited into the mold cavity 116 generally making a multi-layered substrate formed by the process.

In this exemplary embodiment and any other variations, the first mold die is referred to as the mold cavity, and the second mold die is referred to as the mold core. The references to cavity and core relate to the front and back of the component, with the front, in many instances being seen by the vehicle occupant. This invention can be practiced, however, with either of the mold dies being mounted to the lower platen and without any need for naming the mold dies as the mold cavity and mold core.

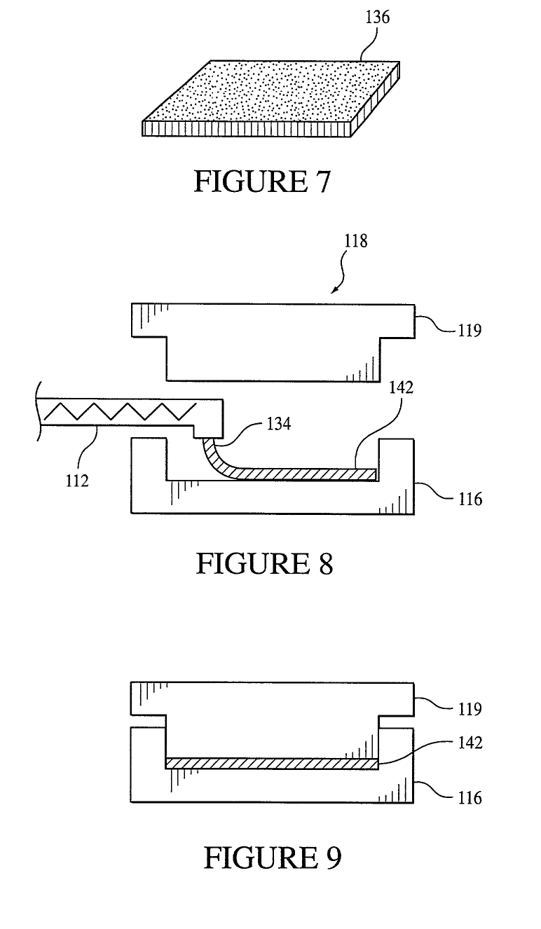

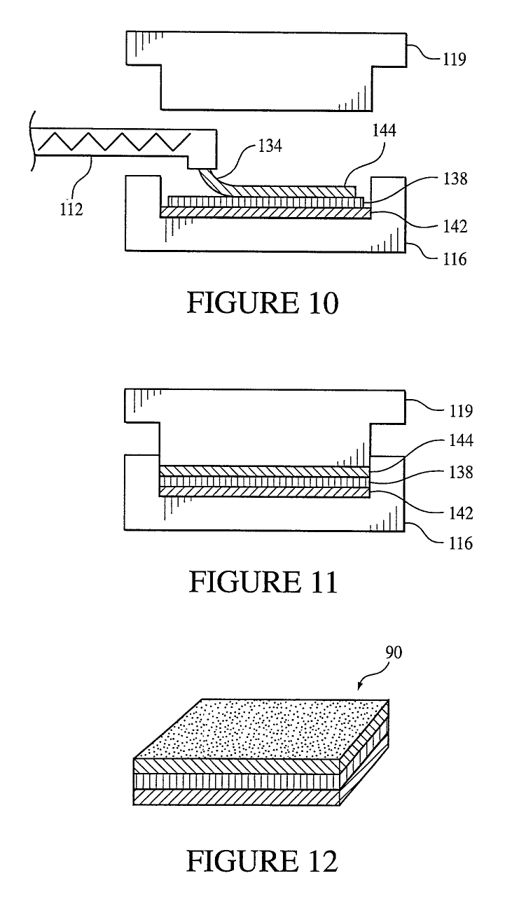

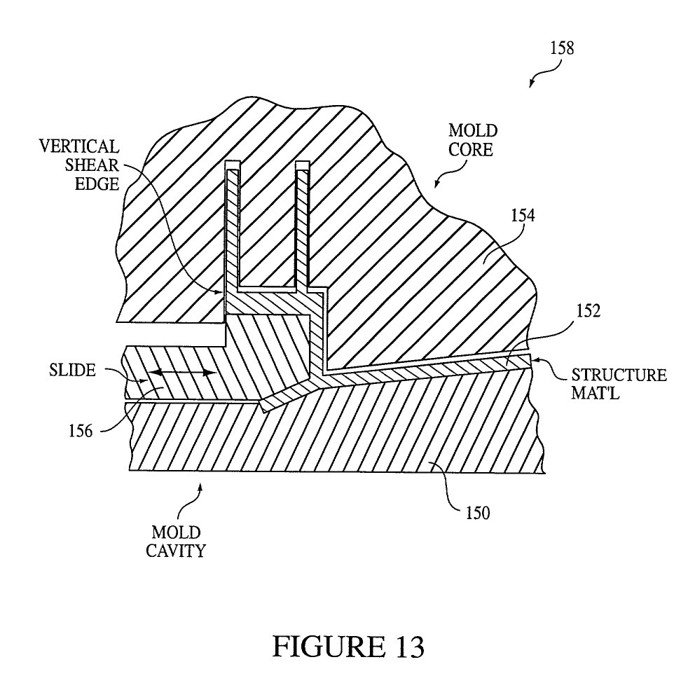

Referring now to FIG. 7, an exemplary embodiment of a blank core material 136 is shown. The blank core material 136 can be a honeycomb material, plascore, molded expanded polypropylene (EPP), foamed thermoplastic material, any low density thermoplastic material which can be shaped, or any high strength-to-weight material that can be used. The blank core material 136 is initially in a form that is prepared for shaping. The blank core material 136 is precut into a form or shape to provide a core material 138 (shown in FIG. 10) suitable for the part design. The core material 138 is sized to fit into the mold cavity 116 with a sufficient margin remaining to allow for an extrudate 134 to be disposed around the core material 138. In an exemplary embodiment, the core material 138 is sized using low-cost/quick-tooling techniques to fit into the mold cavity 116 with about a one to two millimeter thickness of clearance of molded plastic around the core materail 138. The core material 138 substantially forms the internal portion of the panel (see FIG. 12). The core material 138 provides volume and shape to patterns of the panel 90. In addition, core material 138 provides the structural integrity and/or energy absorbing properties of the panel 90.

Referring now to FIG. 8, an exemplary embodiment of an extrusion deposition unit 112 and mold tool 118 for manufacturing a panel 90 is shown. The mold cavity 116 is set to receive a quantity of extrudate 134 from the extrusion deposition unit 112.

The extrusion deposition unit 112 is fed with a material to be deposited in the mold cavity 116. A skin layer 142 makes up a part of the panel 90. Depositing extrudate 134 into the mold cavity 116 forms the skin layer 142. The skin layer 142 can be an elastomeric or a rigid thermoplastic material. The skin layer 142 can be unfilled material or a reinforced material. The skin layer 142 can be reinforced by glass fiber, natural fiber, or any other reinforcing material.

As shown in FIG. 9, the mold core 119 presses on top of the deposited skin layer 142. The extrudate 134 that was deposited was molten, possessing substantial thermal energy. The mold core 119 is lowered on top of the skin layer 142 and forces or presses the molten material of the skin layer 142 to fill the mold cavity 116. While between the mold core 119 and the mold cavity 116, the skin layer 142 cools. The skin layer 142 does not completely cool, it only partially cools so that it can still deform around a more rigid material. After the skin layer 142 has partially cooled, the mold core 119 is removed to expose the skin layer 142.

As shown in FIG. 10, the core material 138 and another layer of extrudate 134 are deposited into the mold cavity 116. The core material 138 is placed or loaded into the mold tool 118 by robotics or conventional means. The core material 138 can also be initially loaded onto the mold core 119 and then lowered into the mold cavity 116, along with the mold core 119. The core material 138 is contacted with the skin layer 142 and adheres with the skin layer 142. The core material 138 adheres with the skin layer 142 due to the adhesive properties of the skin layer 142. When the mold core 119 is cleared from the mold cavity 116, the extrusion/deposition unit 112 is positioned above the mold cavity 116 to deposit material in the form of extrudate 134 into the mold cavity 116. The material may be reinforced or unfilled; it can be the same material or a different material from the skin layer 142. The extrudate 134 is deposited onto and over the core material 138, and forms another layer called a structure layer 144. The structure layer 144 also contacts the skin layer 142 at the locations the core material 138 is not contacting the skin layer 142.

The mold core 119 is lowered in the process, as shown in FIG. 11. The mold core 119 is lowered onto the structure layer 144. The structure layer is pressed onto the core material 138 and the skin layer 142. The pressure of the mold core 119 on top of the structure layer 144 forces the molten material of the structure layer 144 to fill the mold cavity 116. The pressure of the mold core 119 also presses the core material 138 into the skin layer 142. The structure layer 144 material and the skin layer 142 material flows to totally encapsulate the core material 138. The thermoplastic materials of the structure layer 144 and the skin layer 142 cool and subsequently shrink. The mold core 119 is forced by the press 122 onto the cooling material layers, and follows the layers as they shrink. As an alternative, the mold core 119 can be lowered onto stop blocks that limit its downward travel, with the stop blocks being the desired thickness of the finished panel. This is done when precise thickness dimensions are critical or when shrinkage is minimal. The mold core 119 is removed after the materials have sufficiently cooled. The newly molded panel 90 is removed from the mold cavity 116.

FIG. 12 shows an exemplary embodiment of the panel 90. The panel 90 is made of the core material 138 disposed between the skin layer 142 and the structure layer 144. FIG. 12 shows the edges of the panel 90 in a cross section to demonstrate the layers or substrate structure. Shapes molded by the process can be of a variety of configurations. The panel 90 is inexpensively manufactured while maintaining structural integrity and aesthetic appearance. The panel 90 can also serve as an energy-absorbing component in a vehicle safety system.

Referring now to FIGS. 13-16, a cross sectional view of an end treatment for forming a one-piece functional panel using the extrusion deposit compression molding process in accordance with an exemplary embodiment of the present invention is illustrated.

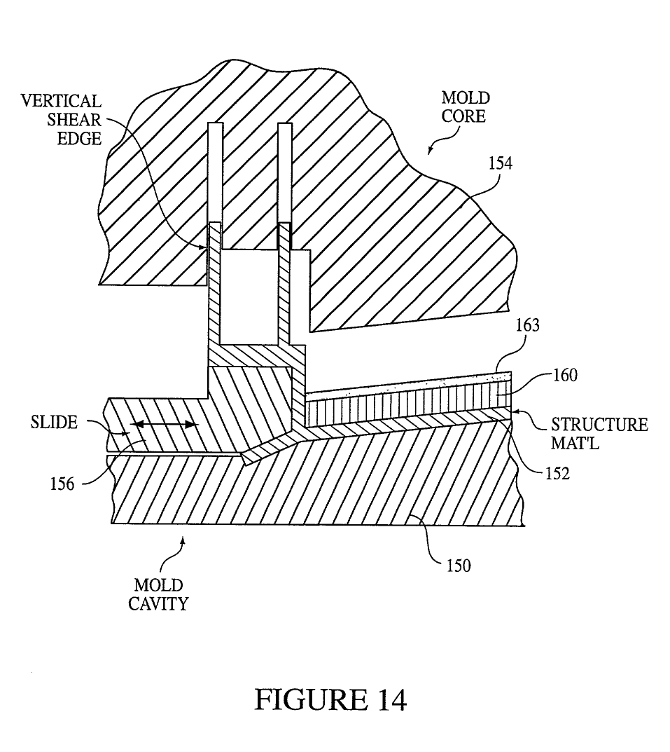

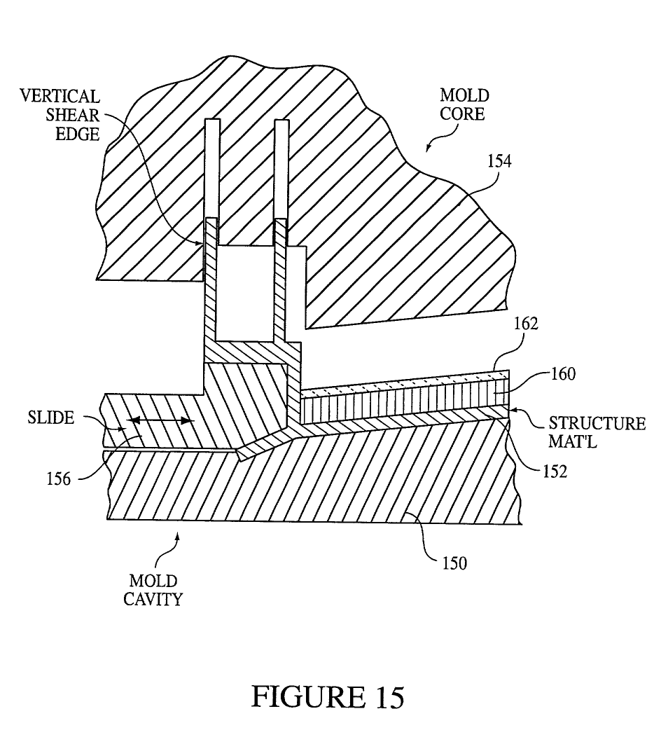

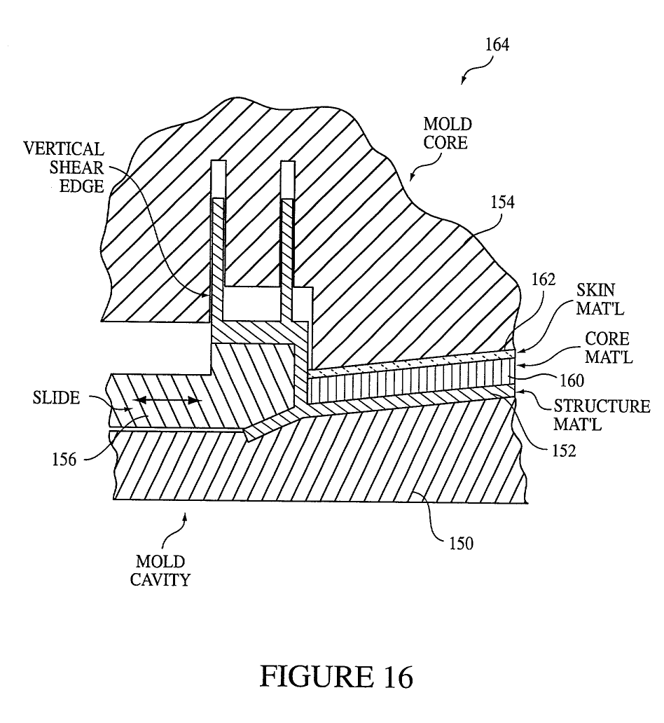

A molten thermoplastic material 152 is deposited onto the mold cavity (or first mold die) 150 using the previously described extrusion deposit compression molding apparatus. The slide 156 is in the forward position, toward the panel or component and away from the outside of the mold. The mold core (or second mold die) 154 is lowered to a first position 158 or position #1 (FIG. 13). As in previous descriptions, after a specific amount of time to allow for partial cooling of the thermoplastic material 152, the mold core is raised a sufficient distance (FIG. 14) and the core material 160 is loaded into the tool using traditional means. Core material 160 is pre-cut and pre-formed as appropriate, similar to previous descriptions. A second amount of molten thermoplastic material 162 which could be the same or different from the first molten material 152 is then deposited into the mold cavity 150 onto the core material 160 using an extrusion deposit compression molding apparatus (FIG. 15). The mold core 154 is then lowered to a second position 164 or position #2 (FIG. 16), forcing the second molten thermoplastic 162 to flow to fill the mold space and encapsulate the edges of the core material 160. It is noted that position # 2 is higher than position # 1 in order to accommodate the thickness of core material 160 and the second material 162. After a suitable amount of time for cooling, the mold core 154 is raised, the slide 156 is retracted, and the molded panel is removed from the mold using traditional means. The result is a molded structural panel with a specific edge treatment for assembly or functional purposes. In using two separate deposits of molten thermoplastic material 152 and 162, the composition of either material may be such that it can be considered structural and as an aesthetic, visible material. In such cases, the material layers can be designated as the structure layer and the skin layer or vice versa.

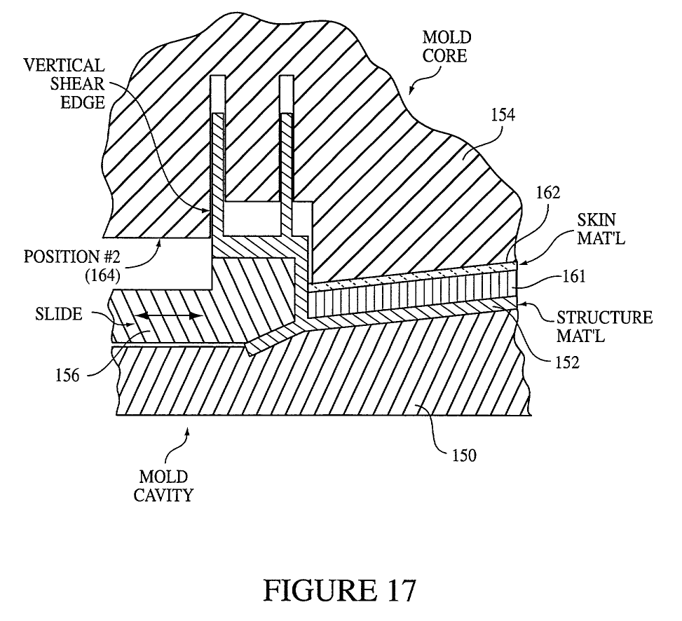

As an alternative, and referring now to FIG. 17 and considering the previous description and all other variations of the process previously described, as an alternative to the core material 160 (and the steps required for pre-cutting, pre-forming, and loading), a layer of molten thermoplastic 161 with a blowing agent could be deposited using the extrusion deposit compression molding apparatus in between the previously described first and second layers. In this case, as an intermediate step, the mold core 154 is lowered to a position between position #1 (158) and position #2 (164) which could be designated as position #1.5 and the material 161 with the blowing agent in deposited therein.

As yet another alternative, and considering the previous description and all other variations of the process previously described, a preformed or unformed trim material, which could be vinyl, TPO, cloth, or some other material could be loaded into the mold cavity 150 prior to the previously described first step (deposit of material 152) or onto the mold core 154 prior to the deposition of the second molten thermoplastic material 162.

As a further alternative, all layers including the first molten thermoplastic material 152, the core material 160, and the second molten thermoplastic material 162 could be deposited or loaded into the tool sequentially without closing the tool (lowering the upper tool half) until all of the materials are loaded. This would achieve a complete molded panel with one press closing.

Considering the previous description and all other variations of the process previously described, and as illustrated by the dashed lines in FIG. 13 and prior to the depositing of the second molten thermoplastic material 162, a sheet or mat of fiberglass or natural fiber reinforcing material 163 could be loaded onto the core material 160 into the tool. The second thermoplastic material 162 is then deposited as previously described.

As an alternative to either or both molten thermoplastic layers 152 and 162, a pre-heated sheet of non-reinforced or reinforced thermoplastic material could be utilized.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

1. A method of making a panel comprising:
depositing a first extrudate into a mold cavity or first mold die;
pressing said first extrudate with a mold core or first mold die to form a skin layer;
cooling said skin layer inside said mold cavity;
loading a core material onto said skin layer;
depositing a second extrudate into said mold cavity and onto said core material forming a structure layer;
pressing said structure layer around said core material with said mold core;
pressing said core material into said skin layer;
cooling said structure layer and said skin layer while pressing said mold core against said structure layer and said core material and said skin layer to form a panel;
removing said panel from said mold cavity.

2. The method of making a panel as in claim 1, wherein depositing said extrudate is performed by an extrusion deposit compression process.

3. The method of making a panel as in claim 1, wherein said pressing of said extrudate between said mold core and said mold cavity encloses said skin layer.

4. The method of making a panel as in claim 1, wherein said first extrudate comprises reinforcing material.

5. The method of making a panel as in claim 1, wherein said second extrudate comprises reinforcing material.

6. The method of making a panel as in claim 1, wherein said first extrudate and said second extrudate comprise the same material.

7. The method of making a panel as in claim 1, wherein said core material is a material selected from the group consisting of a honeycomb material, molded expanded polypropylene, foamed thermoplastic material, and low density thermoplastic material which can be shaped.

8. The method of making a panel as in claim 1, wherein said skin layer comprises an elastomeric thermoplastic material.

9. The method of making a panel as in claim 1, wherein said skin layer comprises a rigid thermoplastic material.

10. The method of making a panel as in claim 1, wherein said structure layer comprises an elastomeric thermoplastic material.

11. The method of making a panel as in claim 1, wherein said structure layer comprises a rigid thermoplastic material.

12. The method of making a panel as in claim 1, wherein said cooling and pressing said structure layer and said core and said skin layer to form said panel, said mold core presses and follows said panel as said panel shrinks, wherein surface defects and material stress are relieved.

13. A method of making an object, comprising:
depositing a first extrudate into a first mold die;
pressing said first extrudate with a second mold die by advancing said second mold die to a first position with respect to said first mold die;
cooling said first extrudate;
removing said second mold die from said first position;
loading a core material onto said first extrudate;
depositing a second extrudate onto said first extrudate and onto said core material forming a structure layer;
pressing said structure layer around said core material with said second mold die by advancing said second mold die to a second position with respect to said first mold die, said second position being further away from said first mold die than said first position;
cooling said structure layer while pressing said second mold die against said structure layer, said core material and said first extrudate to form an object; and
removing said object from said first mold die.

14. The method as in claim 13, wherein a pre-formed trim material is inserted into said first mold die prior to the deposition of said first extrudate.

15. The method as in claim 13, wherein a preformed trim material is inserted into said first mold die after said core material and prior to the deposition of said second extrudate.

16. The method as in claim 13, wherein a reinforcing material is inserted into said first mold die after said core material and prior to the deposition of said second extrudate.

17. The method as in claim 16, wherein said reinforcing material is a fiberglass mat.

18. The method as in claim 16, wherein said reinforcing material is a natural reinforcing material.

19. The method as in claim 13, wherein said first extrudate is a pre-heated sheet of thermoplastic material.

20. The method as in claim 13, wherein said pre-heated sheet of thermoplastic material is reinforced.

21. The method as in claim 13, wherein said second extrudate is a pre-heated sheet of thermoplastic material.

22. A method of making an object, comprising:
depositing a first extrudate into a first mold die;
manipulating an edge portion of said first extrudate by a slide member being configured for sliding with respect to said first mold die;
pressing said first extrudate with a second mold die by advancing said second mold die to a first position with respect to said first mold die, said second mold die being configured to engage a portion of said slide when said second mold die is in said first position;
cooling said first extrudate inside said mold cavity;
removing said second mold die from said first position;
loading a core material onto said first extrudate;
depositing a second extrudate into said mold cavity and onto said core material forming a structure layer;
pressing said structure layer around said core material with said second mold die by advancing said second mold die to a second position with respect to said first mold die, said second position being further away from said first mold die than said first position;
cooling said structure layer and while pressing said second mold die against said structure layer and said core material and said first extrudate to form an object; and
removing said object from said first mold die.

23. A method of making an object, comprising:
depositing a first extrudate into a first mold die;
pressing said first extrudate with a second mold die by advancing said second mold die to a first position with respect to said first mold die;
cooling said first extrudate;
removing said second mold die from said first position;
depositing a second extrudate onto said first extrudate and into said first mold die;
pressing said second extrudate with said second mold die by advancing said second mold die to a second position with respect to said first mold die, said second position being further away from said first mold die than said first position;
cooling said second extrudate;
removing said second mold die from said second position;
depositing a third extrudate into said first mold die and onto said second extrudate;
pressing said third extrudate with said second mold die by advancing said second mold die to a third position with respect to said first mold die, said third position being further away from said first mold die than said second position;
cooling said third extrudate while pressing said second mold die against said first mold die to form an object; and
removing said object.

24. The method as in claim 23, wherein said second extrudate includes a blowing agent.

25. A method of making an object, comprising:
depositing a first extrudate into a first mold die;
loading a core material onto said first extrudate;
depositing a second extrudate onto said core material forming and said first extrudate;
pressing said first extrudate, said core material and said second extrudate by a said second mold die by advancing said second mold die towards said first mold die, said first mold die being fixedly positioned;
cooling said first extrudate, said core material and said second extrudate while pressing said second mold die against said first mold die to form the object; and
removing the object from said first mold die.

26. The method as in claim 25, wherein the object is a panel for use in a vehicle.

27. The method as in claim 25, wherein the object is a component part of a vehicle.
